(19) United States
(12) Patent Application Publication
(10) Pub. No.: US 2012/0045257 A1
(43) Pub. Date: Feb. 23, 2012

(54) ENDLESS BELT, INTERMEDIATE TRANSFER BELT UNIT, IMAGE FORMING APPARATUS AND METHOD FOR MANUFACTURING THE ENDLESS BELT

(76) Inventors: Fumito Mizoguchi, Osaka (JP); Toshiki Takiguchi, Osaka (JP); Hiroyuki Murai, Osaka (JP)

(21) Appl. No.: 13/182,042

(22) Filed: Jul. 13, 2011

(30) Foreign Application Priority Data
Aug. 18, 2010 (JP) 2010-182758

(51) Int. Cl. G03G 15/01; B32B 37/10; B65G 21/20; B32B 37/02

(52) U.S. Cl. 399/302; 198/837; 156/306.3

(57) ABSTRACT

An intermediate transfer belt includes a belt body and a first and a second travelling guide ribs. The first and the second travelling guide ribs are respectively provided in a first edge portion and a second edge portion in width direction in an internal perimetric face of the belt body. A first joint of the first travelling guide rib and a second joint of the second travelling guide rib are disposed so as to be apart from each other in a circumferential direction of the belt body at least not less than a distance corresponding to a semicircle of an intermediate transfer belt drive roller.

### CROSS REFERENCE

This Nonprovisional application claims priority under 35 U.S.C. §119(a) on Patent Application No. 2010-182758 filed in Japan on Aug. 18, 2010, the entire contents of which are hereby incorporated by reference.

### BACKGROUND OF THE INVENTION

The present invention relates to an endless belt in either side edge of which is provided with a travelling guide, to an intermediate transfer belt unit and an image forming apparatus each equipped with the endless belt, and to a method for manufacturing the endless belt.

Conventionally, among the endless belts passed over a plurality of rollers in a tensioned condition, there has been one that employs a configuration in which a travelling guide member is provided in either side edge of the endless belt in order to prevent the endless belt from deviating toward the axial directions of the rollers (lateral deviation) as the rollers rotate.

For example, in the prior art, an image forming apparatus is disclosed in which lateral deviation of an intermediate transfer belt is prevented by a thin wire-shaped rib member stuck onto either side edge of an internal perimetric face of the intermediate transfer belt along its circumferential direction (for instance, refer to Japanese Patent Unexamined Publication No. 2007-52417 bulletin).

Additionally, in the technique according to the patent literature, a configuration is also employed in which a change in belt conveyance speed of the intermediate transfer belt attributable to a slit at a joint of the rib member is reduced, even at the slit at the joint of the rib member, by a support roller that is provided on either side of a tension roller the intermediate transfer belt is passed over in a tensioned condition and that supports both end portions of the rib member.

However, with the technique according to the above mentioned patent literature, as shown in FIG. 1A and FIG. 1B, the rib members 196 and 198 in either side edge of the internal perimetric face of the intermediate transfer belt 194 are provided in such a manner that positions of the joints of the rib members 196 and 198 are the same one another in the circumferential direction of the intermediate transfer belt 194, so that the joints of the rib members 196 and 198 in either side edge pass through the same roller at the same time. As a result, the technique is liable to the behavioral change of the intermediate transfer belt 194 when the joints of the rib members 196 and 198 pass through a roller region in the course of travel of the intermediate transfer belt 194, so that it is likely to cause an occurrence of an image defect.

Besides, what has been experienced when a downtime in a state in which the joints of the rib members 196 and 198 in either side edge at the same time stay wrapping around the same roller extends to a long period of time is that the intermediate transfer belt 194 is likely to be subjected to a load acting thereon; and that this results in occurrences of bending strain, sharp bending and/or the like at joint portions and therefore causes deterioration of durability of the intermediate transfer belt 194.

The present invention is directed to providing an endless belt capable of achieving satisfactory travelling performance and durability, an intermediate transfer belt unit and an image forming apparatus each provided with the endless belt, and a is method for manufacturing the endless belt.

### SUMMARY OF THE INVENTION

An endless belt according to the present invention includes a belt body and a travelling guide member. The belt body has an endless shape, and is configured so as to be passed over a plurality of rollers in a tensioned condition.

The travelling guide member is provided in each of a first edge portion and a second edge portion in width direction in an internal perimetric face of the belt body. The travelling guide member is formed with a long film-like sheet body stuck onto the belt body along a circumferential direction thereof.

Further, a joint of the travelling guide member provided in the first edge portion and a joint of the travelling guide member provided in the second edge portion are disposed so as to be apart from each other in the circumferential direction of the belt body at least not less than a distance corresponding to a semicircle of a roller having the largest diameter among the plurality of rollers.

With this configuration, the joint of the travelling guide member provided in the first edge portion and the joint of the travelling guide member provided in the second edge portion are prevented from passing through the same roller at the same time. Accordingly, behavioral change of the endless belt when either of the joints of the travelling guide members passes through a roller can be reduced to a small degree; so that smooth travelling performance of the endless belt is secured, and thus an occurrence of a deficiency such as image defect attributable to the behavioral change of the endless belt is restrained adequately.

In addition, the endless belt is securely prevented from being left for a long period of time in a state in which the joint of the travelling guide member provided in the first edge portion and the joint of the travelling guide member provided in the second edge portion wrap around the same roller together. Therefore, an occurrence of a deficiency such as bending strain or sharp bending at joint portions is restrained; as a result, deterioration of durability of the intermediate transfer belt is prevented.

The present invention makes it possible for an endless belt that is provided with a travelling guide member in either side edge of its internal perimetric face to achieve satisfactory travelling performance and durability.

### BRIEF DESCRIPTION OF THE DRAWINGS

FIG. 1A is a perspective view showing a configurative outline of a conventional endless belt.

FIG. 1B is a top view showing the configurative outline of the conventional endless belt.

FIG. 2 is a drawing showing an outline of an image forming apparatus according to an embodiment of the present invention.

FIG. 3A is a sectional view showing an outline of an intermediate belt unit along a belt travelling direction.

FIG. 3B is a sectional view showing an outline of the intermediate belt unit along a direction perpendicular to the belt travelling direction.

FIG. 4A is a perspective view showing a configurative outline of an endless belt according to an embodiment of the present invention.

FIG. 4B is a top view showing the configurative outline of the endless belt according to the embodiment of the present invention.

FIG. 5A is a drawing explaining a relationship between the number of support rollers over which an intermediate transfer belt is passed in a tensioned condition and an angle (wrap angle) over which the intermediate transfer belt wraps around a certain support roller (when the number of the support rollers is 4).

FIG. 5B is a drawing explaining a relationship between the number of support rollers over which the intermediate transfer belt is passed in a tensioned condition and an angle (wrap angle) over which the intermediate transfer belt wraps around a certain support roller (when the number of the support rollers is 3).

FIG. 5C is a drawing explaining a relationship between the number of support rollers over which the intermediate transfer belt is passed in a tensioned condition and an angle (wrap angle) over which the intermediate transfer belt wraps around a certain support roller (when the number of the support rollers is 2).

FIG. 6 is a schematic drawing showing an example of a configurative outline of a travelling guide member pasting apparatus.

FIG. 7 is a diagram explaining an example of a travelling guide member pasting process.

FIG. 8 is a schematic drawing showing another example of a configurative outline of a travelling guide member pasting apparatus.

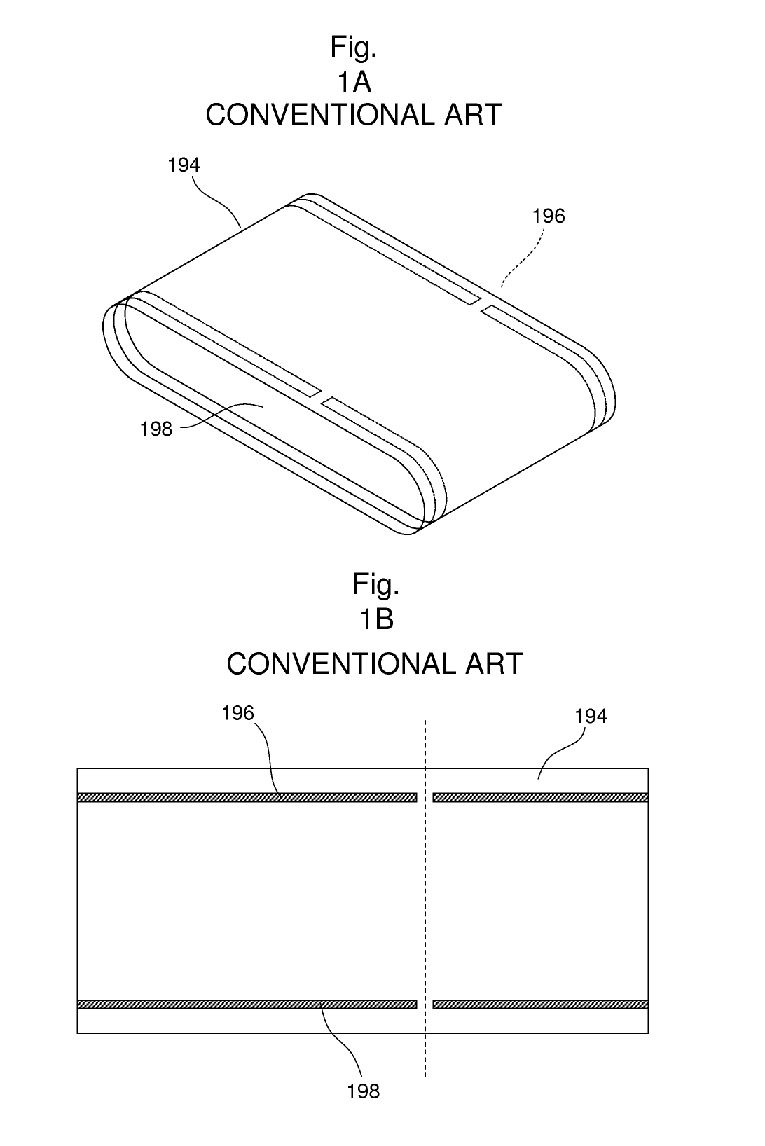

### DETAILED DESCRIPTION OF THE INVENTION

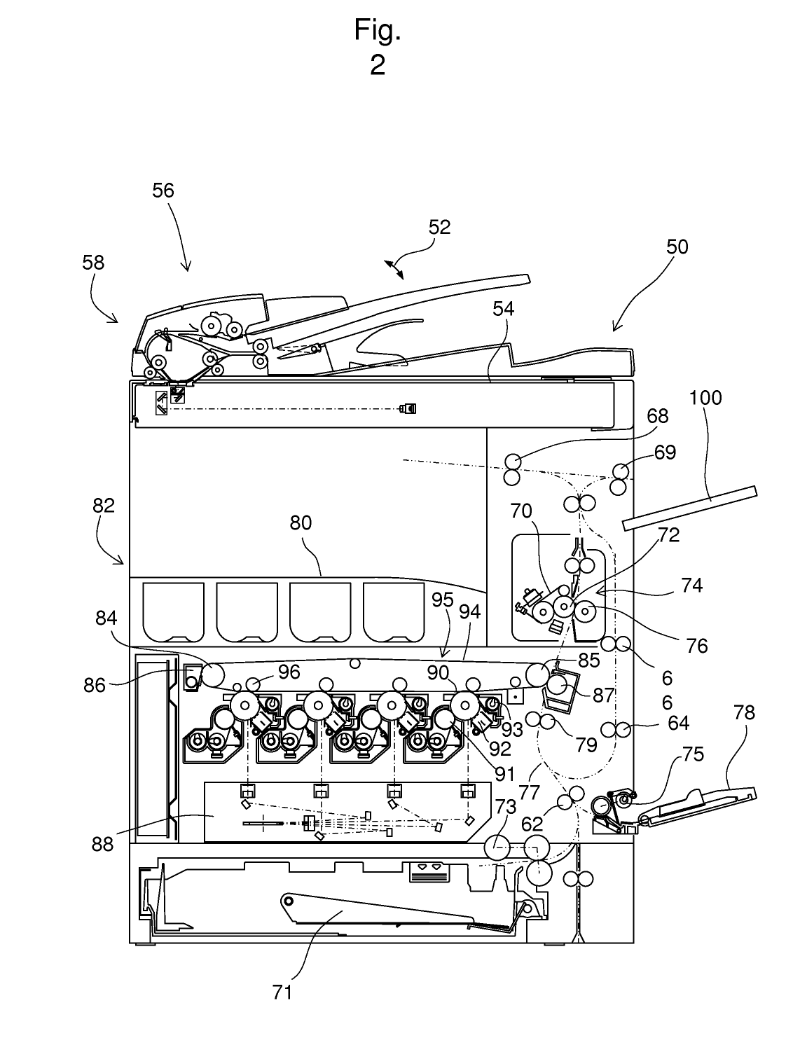

FIG. 2 is a drawing showing an outline of an image forming apparatus 50 according to an embodiment of the present invention. The image forming apparatus 50 is one that forms a multicolored or a monochromatic image onto a predetermined paper sheet (recording medium) depending on image data that have been transmitted from outside, and includes an image forming section 82 and a document reading section 58.

The image forming section 82 includes four image forming stations that form black (K), cyan (C), magenta (M) and yellow (Y) color images respectively. Each of the image forming stations includes a developing device 91, a photoreceptor drum 90, a cleaner unit 93 and an electrostatic charger 92.

The image forming section 82 further includes an optical scanner 88, an intermediate transfer belt unit 95, a fuser unit 74, a paper feed cassette 71, a first copy receiving tray 80, a second copy receiving tray 100, a plurality of flappers (not illustrated) for changing conveyance directions of the paper sheet, and so forth.

On an upside of the image forming section 82 is provided a document loading table 54 made of a transparent glass on which a document is placed, and above the document loading table 54 is installed an automatic document processing unit 56. The automatic document processing unit 56 automatically conveys the document onto the document loading table 54. Also, the automatic document processing unit 56 is configured so as to be swung freely, and thereby enables a user to place the document manually on the document loading table 54 when upside thereof is open.

The electrostatic charger 92 is a charging means to charge a surface of the photoreceptor drum 90 uniformly at a predetermined electrostatic potential; and other than a non-contact type electrostatic charger as shown in FIG. 2, a contact type electrostatic charger such as roller or brush is occasionally used.

The optical scanner 88 is configured so as to form on a surface of each of the photoreceptor drums 90 an electrostatic latent image based on the image data inputted.

Each of the developing devices 91 is one that makes an electrostatic latent image formed on the corresponding each of the photoreceptor drums 90 a manifest image with corresponding each of toners for the four colors. Also, the cleaner unit 93 removes and collects the toner which remains on the surface of the photoreceptor drum 90 after an image transfer has been carried out.

The intermediate transfer belt unit 95 disposed above the photoreceptor drum 90 includes an intermediate transfer belt 94, an intermediate transfer belt drive roller 85, an intermediate transfer belt idle roller 84, four intermediate transfer rollers 96 and an intermediate transfer belt cleaning unit 86.

The intermediate transfer belt drive roller 85, the intermediate transfer belt idle roller 84 and the intermediate transfer rollers 96 are configured so as to pass the intermediate transfer belt 94 over them in a tensioned condition. Also, each of the intermediate transfer rollers 96 is configured so as to transfer the toner image on the corresponding photoreceptor drum 90 onto the intermediate transfer belt 94.

The intermediate transfer belt 94 is installed so as to be in contact with each of the photoreceptor drums 90, and performs a function to form a color toner image (multicolored toner image) on the intermediate transfer belt 94 through sequential superimposition of transfer of the toner images of respective colors formed on the photoreceptor drums 90 onto the intermediate transfer belt 94. The intermediate transfer belt 94 is formed into an endless shape, for example, with a film of around 100 μm through 150 μm thick.

When transfer of the toner image is performed from the photoreceptor drum 90 onto the intermediate transfer belt 94, a high-voltage transfer bias (a high voltage of reverse polarity (+) to the electrostatic charge polarity (−) of the toner) is applied to the intermediate transfer roller 96 in order to transfer the toner image. The intermediate transfer roller 96 is a roller that is formed with a shaft made of metal (e.g., stainless steel) having a diameter of 8 through 10 mm as a base material with the surface thereof covered with an electrically-conductive elastomer (e.g., EPDM, urethane foam or the like). The electrically-conductive elastomer makes it possible to apply a high voltage uniformly to the intermediate transfer belt 94. Although roller geometry is used as a transfer electrode in this embodiment, a brush-shaped transfer electrode or the like may be used otherwise.

The electrostatic latent image that has been made a manifest image on each of the photoreceptor drums 90 depending on the respective hues as described above is superimposed on the intermediate transfer belt 94. The image information that has been superimposed in this manner is transferred onto a paper sheet by a secondary transfer roller 87 that is disposed at a position where the paper sheet comes into contact with the intermediate transfer belt 94 as the intermediate transfer belt 94 rotates.

At this time, the intermediate transfer belt 94 and the secondary transfer roller 87 are caused to press and contact each other with a predetermined nip pressure, and a voltage (a high voltage of reverse polarity (+) to the electrostatic charge polarity (−) of the toner) to cause the toner image to be transferred onto the paper sheet is applied to the secondary transfer roller 87. Further, in order to constantly maintain the above described nip pressure, either the secondary transfer roller 87 or the intermediate transfer belt drive roller 85 is chosen to be made of a rigid material (metal, etc.), then to the other is employed a flexible material such as an elastic roller (elastic rubber roller or foamed resin roller, etc.).

Also, the intermediate transfer belt cleaning unit 86 is set up so as to remove and collect the toner which adhered to the intermediate transfer belt 94 through its contact with the photoreceptor drum 90 as described above or which remains on the intermediate transfer belt 94 after the transfer has been carried out onto the paper sheet by the secondary transfer roller 87; because, otherwise such toner would cause color mixture of toners to occur in the next step. The intermediate transfer belt cleaning unit 86 is equipped with, for instance, a cleaning blade as a cleaning member that is in contact with the intermediate transfer belt 94, and the intermediate transfer belt 94 with which the cleaning blade is in contact is supported from its backside by the intermediate transfer belt idle roller 84.

The paper feed cassette 71 is a tray to store paper sheets to be used for image forming, and is installed on a lower side of the optical scanner 88 of the image forming section 82. The paper sheet(s) to be used for image forming can also be placed on a manual paper feed cassette 78.

Further, the first copy receiving tray 80 is installed above the image forming section 82, and is configured so as to collect the paper sheet having undergone printing with its printed face looking downward. On the other hand, the second copy receiving tray 100 is disposed on an outside of a casing of the image forming apparatus 50, and is configured so as to collect the paper sheet having undergone printing with its printed face looking upward.

Also, in the image forming section 82 is installed a paper sheet conveying path 77 for conveying the paper sheet on the paper feed cassette 71 or the manual paper feed cassette 78, by way of the secondary transfer roller 87 and the fuser unit 74, to either the first copy receiving tray 80 or the second copy receiving tray 100. In close proximity to the paper sheet conveying path 77 extending from the paper feed cassette 71 or the manual paper feed cassette 78 to the first copy receiving tray 80 and the second copy receiving tray 100 are disposed pickup rollers 73, 75, a plurality of conveyance rollers 62, 64, 66, 68, a paper stop roller 79, a secondary transfer roller 87, a fuser unit 74 and so forth.

The conveyance rollers 62, 64, 66, 68 are small rollers to promote and assist conveyance of the paper sheet, and the plurality of them are installed along the paper sheet conveying path 77. Also, the pickup roller 73 is installed in close proximity to an edge of the paper feed cassette 71, picks up the paper sheets from the paper feed cassette 71 piece by piece, and supplies it to the paper sheet conveying path 77. Similarly, the pickup roller 75 is installed in close proximity to an edge of the manual paper feed cassette 78, picks up the sheets from the manual paper feed cassette 78 piece by piece, and supplies it to the paper sheet conveying path 77.

Also, the paper stop roller 79 is one that holds for a moment the paper sheet being conveyed on the paper sheet conveying path 77, and has a function to convey the paper sheet to the secondary transfer roller 87 with a timing that adjusts the head of the paper sheet to the head of the toner image on the intermediate transfer belt 94.

The fuser unit 74 includes a heating roller 72 and a pressure roller 76; and the heating roller 72 and the pressure roller 76 are configured so as to rotate holding the paper sheet between them. Also, the heating roller 72 is set to a predetermined fusing temperature by a control section based on the signal from a temperature sensor which is not illustrated. The heating roller 72, in cooperation with the pressure roller 76, performs a function of heat fusing on the paper sheet by means of the thermo-compression bonding of the toner to the paper sheet through fusing, mixing and pressure-contacting the multicolored toner image that has been transferred onto the paper sheet. An external heating belt 70 is also provided for heating the heating roller 72 from outside.

Next, paths through which the paper sheet is conveyed are explained in detail. As described above, the image forming apparatus is equipped with the paper feed cassette 71 for receiving the paper sheets beforehand and the manual paper feed cassette 78. In order to feed the paper sheets from these paper feed cassettes 71, 78, and then to lead the paper sheets piece by piece to the paper conveying path 77, the pickup rollers 73, 75 are respectively disposed.

The paper sheet conveyed from either of the paper feed cassettes 71, 78 is conveyed to the paper stop roller 79 by the conveyance roller 62 of the paper sheet conveying path 77. Then, the paper sheet is conveyed to the secondary transfer roller 87 with a timing that adjusts the head of the paper sheet to the head of the image information on the intermediate transfer belt 94, and thereby the image information is written onto the paper sheet. Subsequently, unfixed toner on the paper sheet is melted and stuck thereto by heat while the paper sheet passes through the fuser unit 74; and then through the conveyance roller 68 disposed downstream from the fuser unit 74, the paper sheet is discharged onto the first copy receiving tray 80 or the second copy receiving tray 100.

The above-mentioned conveyance path is the one for single sided printing onto the paper sheet. On the other hand, in the case of duplex printing, the paper sheet that has undergone the single sided printing as described above and has passed through the fuser unit 74 is held at its rear edge by the final conveyance roller 68. Subsequently reversing the rotational direction of the conveyance roller 68 and switching positions of the flappers (not illustrated) cause the paper sheet to be led to a return conveying path on which the conveyance rollers 66, 64 are disposed. Then, the paper sheet from the return conveying path passes through the paper stop roller 79, and on reaching the position at which it comes into contact with the intermediate transfer belt 94, undergoes printing on its rear face. After that, the paper sheet is discharged onto the first copy receiving tray 80.

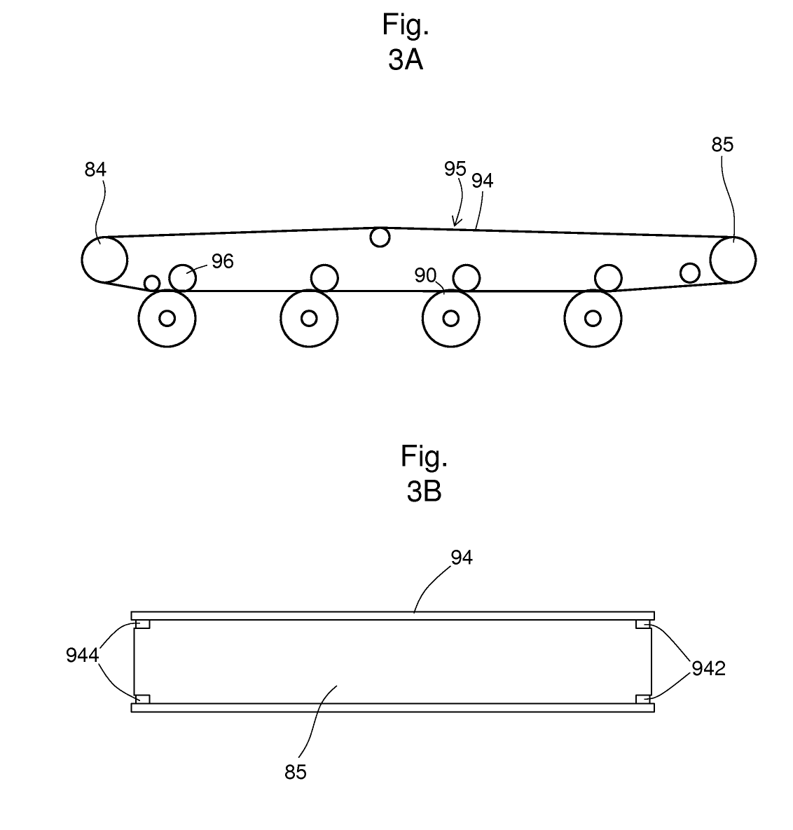

Next, using FIG. 3A and FIG. 3B, configuration of the intermediate belt unit 95 is explained. As shown in the figures above, the intermediate transfer belt 94 of the intermediate belt unit 95 is passed over the intermediate transfer belt idle roller 84, the intermediate transfer belt drive roller 85, and a plurality of rollers including the intermediate transfer rollers 96 in a tensioned condition. In this embodiment, design has been made so that the intermediate transfer belt drive roller 85 has the largest diameter among the intermediate transfer belt idle roller 84, the intermediate transfer belt drive roller 85 and the intermediate transfer rollers 96.

When a rotational drive power is supplied to the intermediate transfer belt drive roller 85, the intermediate transfer belt drive roller 85 rotates, and travel of the intermediate transfer belt 94 starts; then motions of the intermediate transfer belt idle roller 84 and the intermediate transfer rollers 96 follow this. In this regard, in order to prevent the intermediate transfer belt 94 from deviating in axial directions of the intermediate transfer belt idle roller 84, the intermediate transfer belt drive roller 85 and the intermediate transfer rollers 96, a first travelling guide rib 942 and a second travelling guide rib 944 are provided in either edge portion in width direction (direction parallel to the axial directions of the respective rollers) in an internal perimetric face of the intermediate transfer belt 94.

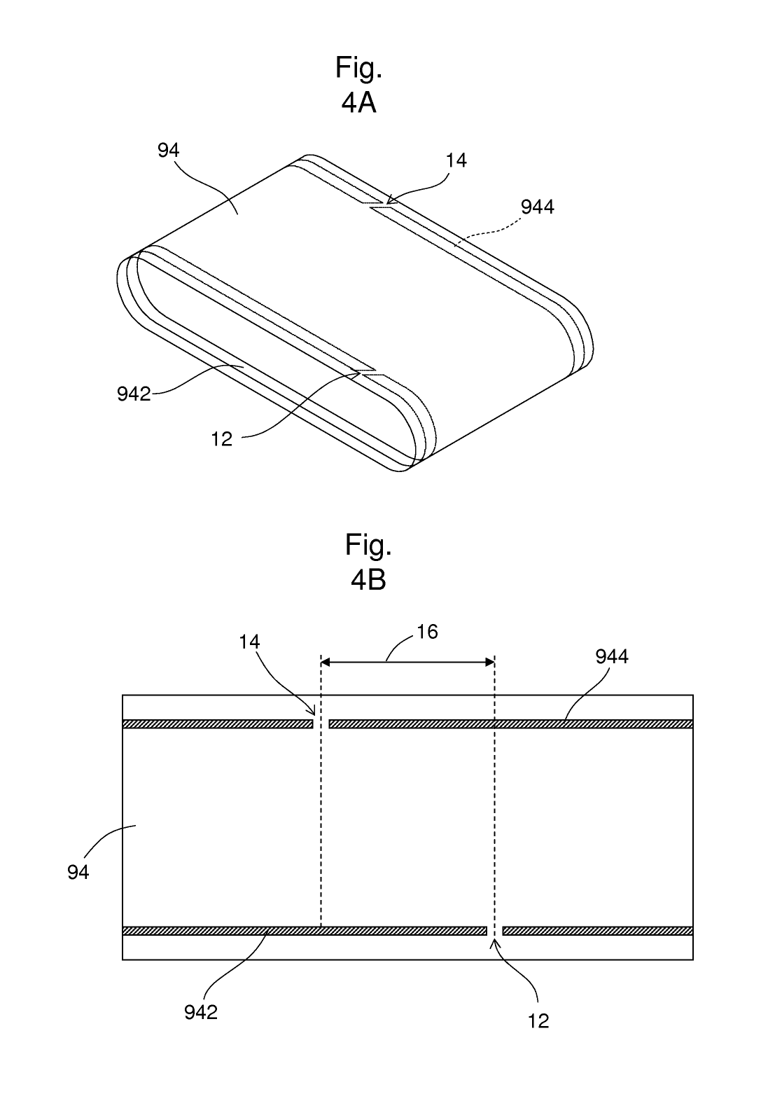

Here, using FIG. 4A and FIG. 4B, configuration of the intermediate transfer belt 94 is explained. As shown in the figures above, the first travelling guide rib 942 is provided in a first edge portion in width direction in the internal perimetric face of the intermediate transfer belt 94, whereas the second travelling guide rib 944 is provided in a second edge portion in the width direction. The first travelling guide rib 942 and the second travelling guide rib 944 are respectively formed with a long film-like sheet member (for instance, urethane sheet), and are stuck onto the internal perimetric face of the intermediate transfer belt 94 with an adhesive.

Since the first travelling guide rib 942 and the second travelling guide rib 944 are stuck along a circumferential direction onto the internal perimetric face of the intermediate transfer belt 94, a first joint 12 is formed between a pasting start point and a pasting end point of the first travelling guide rib 942, while a second joint 14 is formed between a pasting start point and a pasting end point of the second travelling guide rib 944. Here, although an example is illustrated in which both ends in lengthwise direction of each of the first travelling guide rib 942 and the second travelling guide rib 944 are cut obliquely in consideration of stability of travelling of the intermediate transfer belt 94, it is not always necessary to employ such a configuration.

Also, it is preferred that the first joint 12 and the second joint 14 are respectively provided with a predetermined gap. The reason is that providing a suitable gap for the joint position can prevent the first travelling guide rib 942 or the second travelling guide rib 944 from self-overlapping, which would otherwise occur due to a difference in thermal expansion property between the main body (base material) of the intermediate transfer belt 94 and the first travelling guide rib 942 or the second travelling guide rib 944.

In this embodiment, the first joint 12 and the second joint 14 are disposed so as to be apart from each other in the circumferential direction of the intermediate transfer belt 94 at least not less than a distance (refer to the arrow 16 in FIG. 4B) corresponding to one-half of a perimeter of the intermediate transfer belt drive roller 85. The reason is to prevent the first joint 12 and the second joint 14 from wrapping around the same roller at the same time. Here, the distance corresponding to one-half of the perimeter of the intermediate transfer belt drive roller 85 is employed as a reference, because design has been made so that the intermediate transfer belt drive roller 85 has the largest diameter among the intermediate transfer belt idle roller 84, the intermediate transfer belt drive roller 85 and the intermediate transfer rollers 96; however, in a case where another roller has the largest diameter, a distance corresponding to one-half of a perimeter of the roller should be employed as a reference.

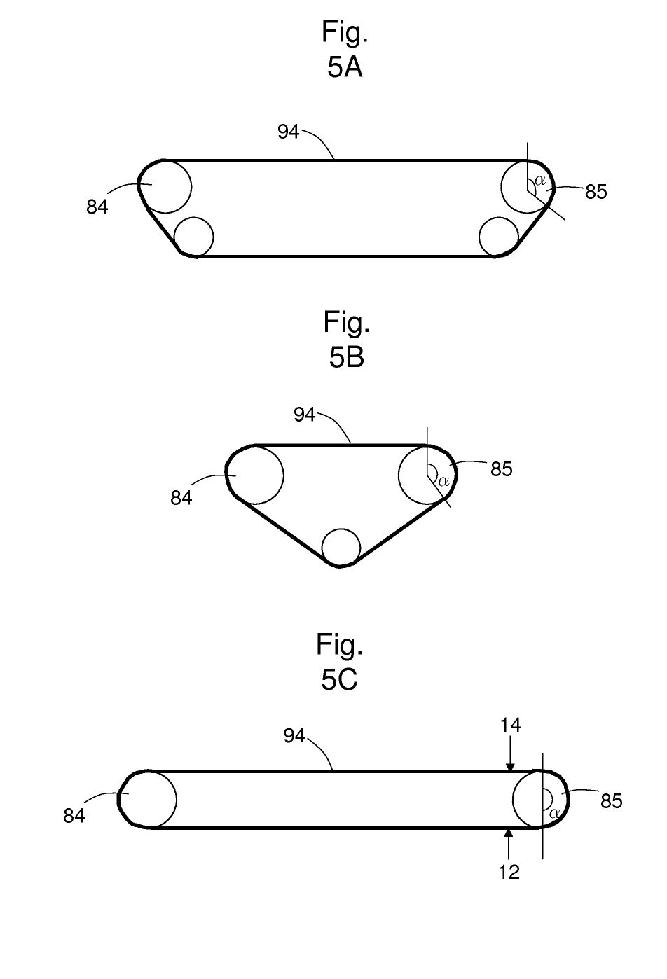

Next, using FIG. 5A through FIG. 5C, technical significance of disposing the first joint 12 and the second joint 14 apart from each other in the circumferential direction of the intermediate transfer belt 94 not less than the distance corresponding to one-half of the perimeter of the intermediaLe transfer belt drive roller 85 is explained. As shown in FIG. 5A and FIG. 5B, as the number of the support rollers over which the intermediate transfer belt 94 is passed in a tensioned condition decreases, an angle (wrap angle) alpha over which the intermediate transfer belt 94 wraps around the intermediate transfer belt drive roller 85 becomes bigger. Then, as shown in FIG. 5C, the angle (wrap angle) alpha reaches 180 degrees (straight angle) when the intermediate transfer belt 94 is supported by two support rollers; however, the angle (wrap angle) alpha never exceeds 180 degrees (straight angle) except for a special case where diameters of two support rollers are extremely different.

For this reason, as in the configuration according to this embodiment, disposing the first joint 12 and the second joint 14 apart from each other in the circumferential direction of the intermediate transfer belt 94 not less than the distance corresponding to one-half of the perimeter of the intermediate transfer belt drive roller 85 having the largest diameter can securely prevent the first joint 12 and the second joint 14 from wrapping around the same roller at the same time. As a result, behavioral change of the intermediate transfer belt 94 when the first and the second joints 12, 14 of the first and the second travelling guide ribs 942, 944 pass through each of the rollers can be reduced to a small degree. Accordingly, smooth travelling performance of the intermediate transfer belt 94 is secured, and thus an occurrence of a deficiency such as an image defect attributable to the behavioral change of the intermediate transfer belt 94 is restrained adequately.

Moreover, the intermediate transfer belt 94 is securely prevented from remaining stationary for a long period of time in a state in which the first and the second joints 12, 14 together wrap around the same roller. Therefore, an occurrence of a deficiency such as bending strain or sharp bending at the first or the second joint 12, 14 in the intermediate transfer belt 194 is restrained; and as a result, deterioration of durability of the intermediate transfer belt 94 is prevented.

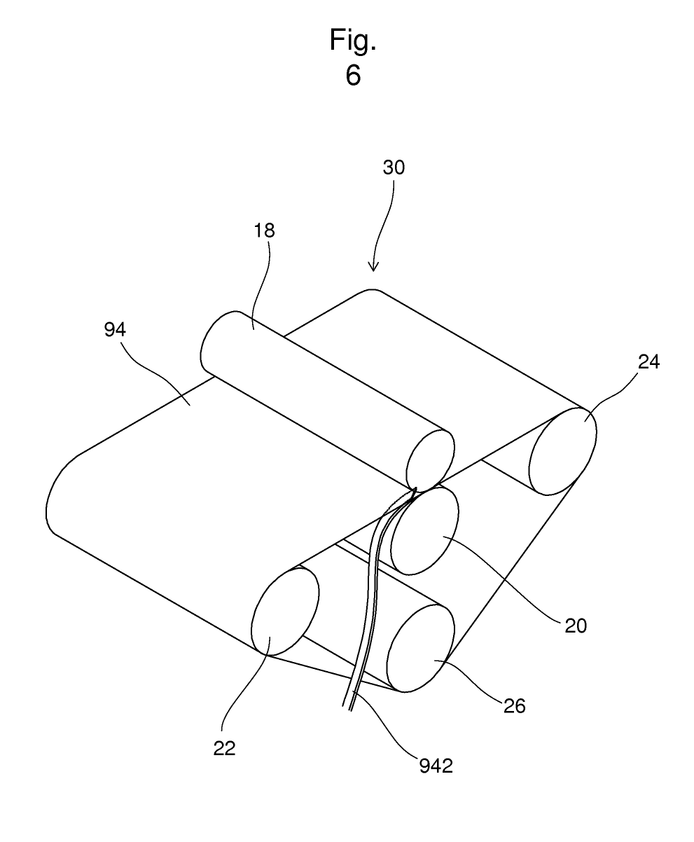

Next, using FIG. 6, a method for manufacturing the intermediate transfer belt 94 is explained. When the first and the second travelling guide ribs 942, 944 are stuck onto the intermediate transfer belt 94, a guide rib pasting apparatus 30 as shown in FIG. 6 is used.

The guide rib pasting apparatus 30 includes an idle roller 22, a drive roller 24, a guide roller 20 and a tension roller 26 each to support the intermediate transfer belt 94. The tension roller 26 is supported movably upward and downward, and a tensile force can be applied to the intermediate transfer belt 94 by the tension roller 26 lowered to a position. Additionally, at a position corresponding to the guide roller 20 is installed a pressure roller 18 movably supported so as to be apart from and get close to (or in touch with) the guide roller 20.

The first and the second travelling guide ribs 942, 944 before they are stuck onto the intermediate transfer belt 94 are respectively covered by a sheet of releasable paper on their adhesive surfaces. When the first and the second travelling guide ribs 942, 944 are adhered, each sheet of releasable paper thereof is removed at its head end portion to a matter of 10 cm, and then, with each exposed adhesive surface being opposed to the internal perimetric face of the intermediate transfer belt 94, the head end portions of the first and the second travelling guide ribs 942, 944 are led to a pressure-bonding section of the guide roller 20 and the pressure roller 18.

From this state, as the intermediate transfer belt 94 is run by the drive roller 24 that is made to rotate while the sheets of releasable paper of the first and the second travelling guide ribs 942, 944 are being removed, the first and the second travelling guide ribs 942, 944 keep on sticking along the circumferential direction onto the internal perimetric face of the intermediate transfer belt 94.

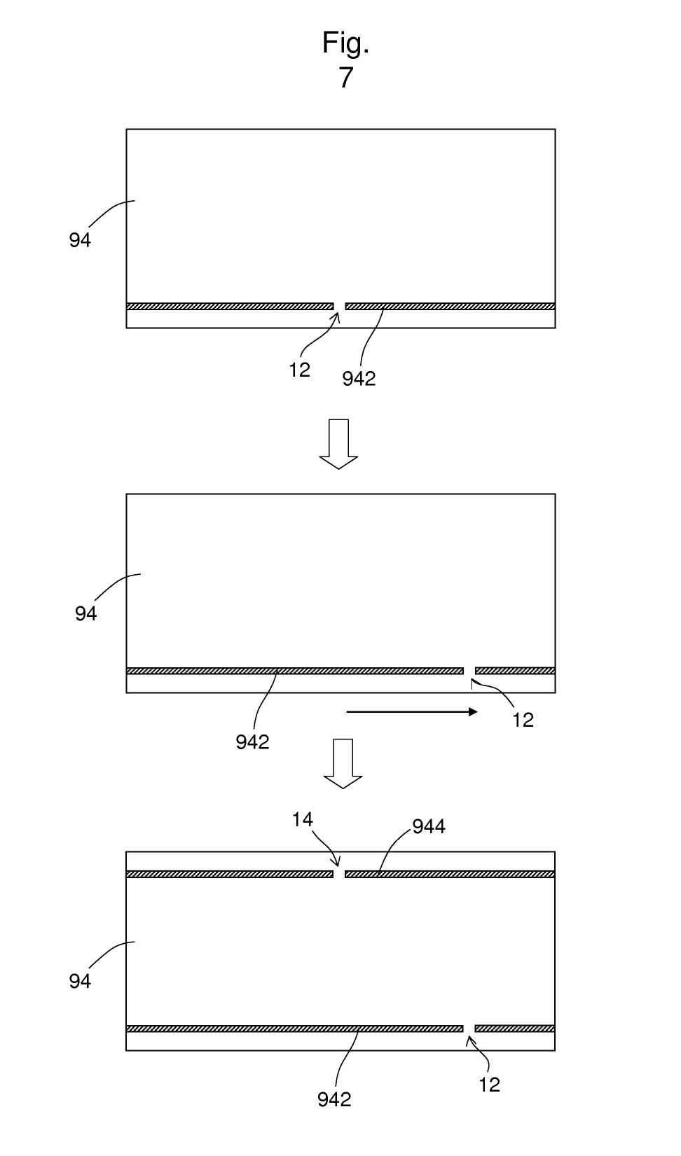

Here, using FIG. 7, a process for sticking the first and the second travelling guide ribs 942, 944 onto the internal perimetric face of the intermediate transfer belt 94 is explained. As shown by the upper diagram of FIG. 7, first, the first travelling guide rib 942 is stuck to the first edge portion along the circumferential direction in the internal perimetric face of the intermediate transfer belt 94.

Next, as shown by the middle diagram of FIG. 7, by the drive roller 24 made to rotate, the intermediate transfer belt 94 is caused to idly travel not less than the distance corresponding to one-half of the perimeter of the intermediate transfer belt drive roller 85.

Subsequently, as shown by the lower diagram of FIG. 7, the second travelling guide rib 944 is stuck to the second edge portion along the circumferential direction in the internal perimetric face of the intermediate transfer belt 94. By following such a procedure, it is easily and securely made possible to have the first joint 12 and the second joint 14 being apart from each other in the circumferential direction of the intermediate transfer belt 94 not less than the distance corresponding to one-half of the perimeter of the intermediate transfer belt drive roller 85.

Although what was explained in FIG. 7 was an example in which the first and the second travelling guide ribs 942, 944 are sequentially stuck onto the internal perimetric face of the intermediate transfer belt 94, it is also possible to stick the first and the second travelling guide ribs 942, 944 simultaneously to either side edge portion of the internal perimetric face of the intermediate transfer belt 94.

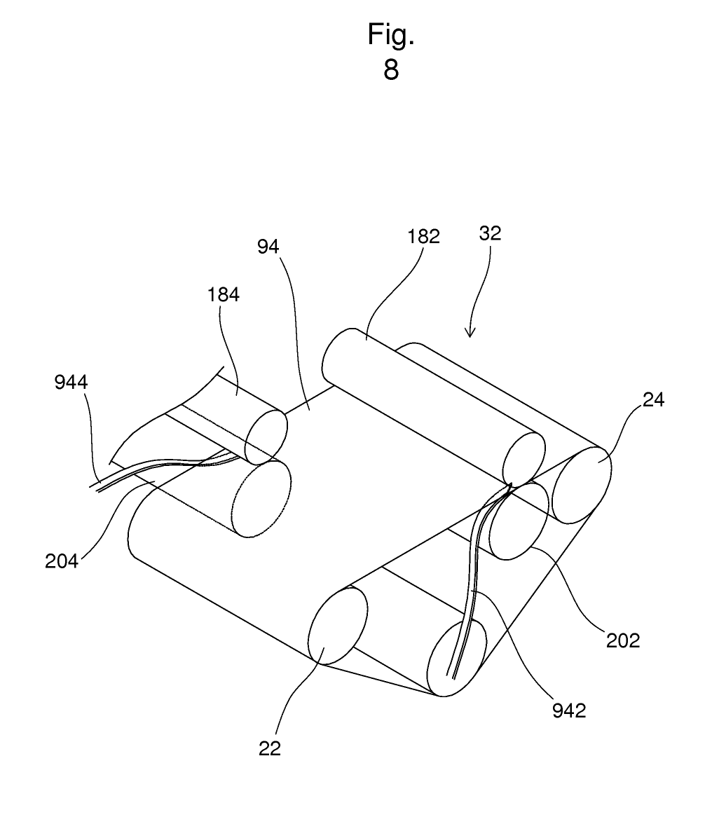

Next, using FIG. 8, another guide rib pasting apparatus 32 is explained as a variation of the guide rib pasting apparatus 30. Basic structures of the guide rib pasting apparatus 30 and the guide rib pasting apparatus 32 are the same. But the guide rib pasting apparatus 32 includes a guide roller 202 and a pressure roller 182 for pasting the first travelling guide rib 942, and a guide roller 204 and a pressure roller 184 for pasting the second travelling guide rib 944, provided separately from each other. A pressure-bonding section of the guide roller 202 and the pressure roller 182 and a pressure-bonding section of the guide roller 204 and The pressure roller 184 are disposed so as to be apart from each other in the circumferential direction of the intermediate transfer belt 94 not less than the distance corresponding to one-half of the perimeter of the intermediate transfer belt drive roller 85. Besides, in consideration of workability in pasting of the first travelling guide rib 942, the guide roller 204 and the pressure roller 184 are disposed in a recessed manner as compared with the guide roller 202 and the pressure roller 182.

When such a guide rib pasting apparatus 32 is used, the head end portion of the first travelling guide rail rib 942 is, with the adhesive surface thereof being opposed to the internal perimetric face of the intermediate transfer belt 94, set to the pressure-bonding section of the guide roller 202 and the pressure roller 182; then the head end portion of the second travelling guide rail rib 944 is, with the adhesive surface thereof being opposed to the internal perimetric face of the intermediate transfer belt 94, set to the pressure-bonding section of the guide roller 204 and the pressure roller 184; and thereby the first and the second travelling guide ribs 942, 944 are stuck to either side edge portion of the internal perimetric face of the intermediate transfer belt 94 at the same time. Then, the first joint 12 and the second joint 14 automatically come to be apart from each other in the circumferential direction of the intermediate transfer belt 94 not less than the distance corresponding to one-half of the perimeter of the intermediate transfer belt drive roller 85.

The above explanation of the embodiments is nothing more than illustrative in any respect, nor should be thought of as restrictive. Scope of the present invention is indicated by claims rather than the above embodiments. Further, it is intended that all changes that are equivalent to a claim in the sense and realm of the doctrine of equivalence be included within the scope of the present invention.

What is claimed is:

1. An endless belt comprising:
a belt body of an endless shape to be passed over a plurality of rollers in a tensioned condition; and
a travelling guide member provided in each of a first edge portion and a second edge portion in width direction in an internal perimetric face of the belt body, the travelling guide member being formed with a long film-like sheet body stuck onto the belt body along a circumferential direction thereof, wherein
a joint of the travelling guide member provided in the first edge portion and a joint of the travelling guide member provided in the second edge portion are disposed so as to be apart from each other in the circumferential direction of the belt body at least not less than a distance corresponding to a semicircle of a roller having the largest diameter among the plurality of rollers.

2. The endless belt as claimed in claim 1 wherein the joint of the travelling guide member provided in the first edge portion and the joint of the travelling guide member provided in the second edge portion are respectively provided with a predetermined gap.

3. An intermediate transfer belt unit for use in an electrophotography-type image forming apparatus including the endless belt as claimed in claim 1 and a plurality of rollers over which the endless belt is passed in a tensioned condition, wherein
a roller having the largest diameter among the plurality of rollers is a drive roller.

4. An intermediate transfer belt unit for use in an electrophotography-type image forming apparatus including the endless belt as claimed in claim 2 and a plurality of rollers over which the endless belt is passed in a tensioned condition, wherein
a roller having the largest diameter among the plurality of rollers is a drive roller.

5. An electrophotography-type image forming apparatus comprising the intermediate transfer belt unit as claimed in claim 3.

6. An electrophotography-type image forming apparatus comprising the intermediate transfer belt unit as claimed in claim 4.

7. A method for manufacturing an intermediate transfer belt wherein a travelling guide member is stuck to either side edge portion in an internal perimetric face of a belt body of an endless shape to be passed over a plurality of rollers in a tensioned condition, the method comprising:
a step for setting the belt body to a guide member pasting apparatus having a plurality of rollers configured so as to cause the travelling guide members to be pressed against and stuck onto the belt body while the belt body is caused to travel;
a step for sticking a first travelling guide member that is formed with a long film-like sheet body to a first edge portion in width direction along a circumferential direction in the internal perimetric face of the belt body;
a step performed by operating the guide member pasting apparatus for causing the belt body to travel in the circumferential direction thereof at least not less than a distance corresponding to a semicircle of a roller having the largest diameter among the plurality of rollers; and
a step for sticking a second travelling guide member that is formed with a long film-like sheet body to a second edge portion in width direction along the circumferential direction in the internal perimetric face of the belt body.

8. A method for manufacturing an intermediate transfer belt wherein a travelling guide member is stuck to either side edge portion in an internal perimetric face of a belt body of an endless shape to be passed over a plurality of rollers in a tensioned condition, the method comprising:
a step for setting the belt body to a guide member pasting apparatus having a plurality of rollers configured so as to cause the travelling guide members to be pressed against and stuck onto the belt body while the belt body is caused to travel, the guide member pasting apparatus including two sets of roller pairs with the sets thereof disposed apart from each other at least not less than a distance corresponding to a semicircle of a roller having the largest diameter among the plurality of rollers; and
a step performed by operating the guide member pasting apparatus for sticking the first travelling guide member and the second travelling guide member that are respectively formed with a long film-like sheet body to the first edge portion and the second edge portion in width direction along the circumferential direction in the internal perimetric face of the belt body at the same time.
